(19) United States
(12) Patent Application Publication
(10) Pub. No.: US 2024/0332627 A1
(43) Pub. Date: Oct. 3, 2024

(54) ELECTROLYTIC SOLUTION AND LITHIUM-METAL SECONDARY BATTERY

(71) Applicant: HONDA MOTOR CO., LTD., Tokyo (JP)

(72) Inventors: Takeshi FUJINO, Saitama (JP); Pu QIAN, Saitama (JP)

(21) Appl. No.: 18/587,954

(22) Filed: Feb. 27, 2024

(30) Foreign Application Priority Data
Mar. 31, 2023 (JP) 2023-059645

(51) Int. Cl. H01M 10/0569; H01M 10/052; H01M 10/0568

(52) U.S. Cl. CPC H01M 10/0569; H01M 10/052; H01M 10/0568; H01M 2300/004

(57) ABSTRACT

An electrolytic solution according to this invention includes an organic solvent; lithium bis(fluorosulfonyl)imide; and an alkaline earth metal salt, the alkaline earth metal salt being one or both of an alkaline earth metal salt of bis(fluorosulfonyl)imide or an alkaline earth metal salt of bis(trifluoromethane)sulfonimide, and the alkaline earth metal salt being contained in a range of 0.1% by mass or more and 1.0% by mass or less.

This application is based on and claims the benefit of priority from Japanese Patent Application No. 2023-059645, filed on 31 Mar. 2023, the content of which is incorporated herein by reference.

### BACKGROUND OF THE INVENTION

### Field of the Invention

The present invention relates to an electrolytic solution and a lithium-metal secondary battery.

### Related Art

In recent years, research and development have been conducted on secondary batteries that contribute to an increase in energy efficiency in order to ensure that more people have access to affordable, reliable, sustainable, and advanced energy. For example, a lithium-metal secondary battery that includes a positive electrode including a positive electrode current collector and a positive electrode composite layer containing a lithium composite oxide; a negative electrode including a negative electrode current collector and a lithium metal layer; and a separator impregnated with an electrolytic solution has been known as a secondary battery.

As the electrolytic solution, for example, a non-aqueous electrolytic solution in which an electrolytic salt is dissolved in a non-aqueous solvent has been known (see Patent Document 1). Here, the electrolytic salt includes at least one first lithium salt selected from LiPF₆, LiBF₄, LiN (SO₂F)₂, LiN (SO₂CF₃)₂, or LiN (SO₂C₂F₅)₂ and at least one second lithium salt selected from a lithium salt having an oxalate backbone, a lithium salt having a phosphate backbone, or a lithium salt having a S═O group. Furthermore, the first lithium salt and the second lithium salt are four types or more in total.
Patent Document 1: PCT International Publication No. WO2016/009994

### SUMMARY OF THE INVENTION

Meanwhile, technologies related to secondary batteries face the problem of needing to improve capacity and cycle life. A lithium-metal secondary battery has an improved capacity since its negative electrode active material is a lithium metal. However, the lithium-metal secondary battery has a problem in that repeated charges and discharges results in a lower Coulombic efficiency and thus a lower capacity maintenance rate.

An object of the present application is to provide an electrolytic solution capable of providing a lithium-metal secondary battery with a high capacity maintenance rate even after repeated charges and discharges in order to solve the above problem. Thus, this application contributes to an increase in energy efficiency.

The present inventors have found that the above problem can be solved by adding a predetermined alkaline earth metal salt in a predetermined amount to an electrolytic solution including an organic solvent and lithium bis(fluorosulfonyl)imide [LiFSI:(LiN(SO₂F)₂)], and thus the present invention has been completed. Therefore, the present invention provides the following aspects.

(1) An electrolytic solution including:an organic solvent; lithium bis(fluorosulfonyl)imide; and an alkaline earth metal salt, the alkaline earth metal salt being one or both of an alkaline earth metal salt of bis(fluorosulfonyl)imide or an alkaline earth metal salt of bis(trifluoromethane)sulfonimide, and the alkaline earth metal salt being contained in a range of 0.1% by mass or more and 1.0% by mass or less.

The electrolytic solution according to (1) includes the above-described alkaline earth metal salt in the above-described range, enabling a lithium-metal secondary battery with a high capacity maintenance rate even after repeated charges and discharges.

(2) The electrolytic solution according to (1), in which the organic solvent is an ether solvent.

(3) The electrolytic solution according to (2), in which the ether solvent includes a chain ether having two oxygen atoms per solvent molecule and a hydrofluoroether.

The electrolytic solution according to (3) has improved durability since the chain ether having two oxygen atoms per solvent molecule has a stable coordination structure.

(4) The electrolytic solution according to (3), in which a molar ratio of a content of the chain ether and a content of the lithium bis(fluorosulfonyl)imide is in a range of 1:2.0 to 2.7.

The electrolytic solution according to (4) contains the chain ether and the lithium bis(fluorosulfonyl)imide in the above-described range, enabling a lithium-metal secondary battery with a higher capacity maintenance rate even after repeated charges and discharges.

The electrolytic solution according to any one of (1) to (4), in which the lithium bis(fluorosulfonyl)imide has a concentration in a range of 2.0 mol/L or more to 3.0 mol/L or less.

(5) The electrolytic solution according to (5) has a high concentration of the lithium bis(fluorosulfonyl)imide and thus an improved coulombic efficiency, enabling a lithium-metal secondary battery with an even higher capacity maintenance rate.

(6) The electrolytic solution according to any one of (1) to (5), further including at least one compound selected from the group consisting of an oxalato complex compound, a carbonate compound, a sulfone compound, and a sulfoxide compound, the compound being contained in a range of 0.1% by mass or more and 1.0% by mass or less.

The electrolytic solution according to (6) further includes the above-described compound in the above-described range, enabling a lithium-metal secondary battery with a higher capacity maintenance rate.

(7) A lithium-metal secondary battery including an electrolytic solution according to any one of (1) to (6).

The lithium-metal secondary battery according to (7) has a high capacity maintenance rate even after repeated charges and discharges since it includes the above-described electrolytic solution. Therefore, the lithium-metal secondary battery according to (7) has improved capacity and cycle life.

The present invention can provide an electrolytic solution capable of providing a lithium-metal secondary battery with a high capacity maintenance rate even after repeated charges and discharges.

### DETAILED DESCRIPTION OF THE INVENTION

Embodiments of the present invention will now be described.

[Electrolytic solution]

An electrolytic solution according to the present embodiment includes an organic solvent, lithium bis(fluorosulfonyl)imide [LiFSI: (LiN(SO₂F)₂)], and an alkaline earth metal salt. The alkaline earth metal salt may be one or both of an alkaline earth metal salt of bis(fluorosulfonyl)imide or an alkaline earth metal salt of bis(trifluoromethane)sulfonimide.

A concentration of LiFSI in the electrolytic solution may be, for example, in a range of 2.0 mol/L or more to 3.0 mol/L or less or in a range of 2.2 mol/L or more and 2.8 mol/L or less.

The alkaline earth metal salt may be a magnesium salt, a calcium salt, a strontium salt, and a barium salt, or a magnesium salt and a calcium salt. The alkaline earth metal salt may be, for example, magnesium bis(fluorosulfonyl)imide {Mg(FSI)₂:Mg[N(SO₂F)₂]₂}, magnesium bis(trifluoromethane)sulfonimide {Mg(TFSI)₂:Mg[N(SO₂CF₃)₂]₂}, calcium bis(fluorosulfonyl)imide {Ca(FSI)₂:Ca[N(SO₂F)₂]₂}, calcium bis(trifluoromethane)sulfonimide {Ca(TFSI)₂:Ca[N(SO₂CF₃)₂]₂}. The alkaline earth metal salt may be used alone or two or more thereof may be used in combination. A content of the alkaline earth metal salt in the electrolytic solution may be in a range of 0.1% by mass or more and 1.0% by mass or less. The content of the alkaline earth metal salt is calculated as a content of the alkaline earth metal salt relative to a total amount of the electrolytic solution (Content of alkaline earth metal salt/Total amount of electrolytic solution×100). The content of the alkaline earth metal salt may also be in a range of 0.3% by mass or more and 0.7% by mass or less.

The organic solvent is not particularly limited as long as a lithium salt dissolves therein. The organic solvent may be, for example, an ether solvent, a carbonate solvent, an ester solvent, sulfone, or nitrile. The organic solvent may be used alone or two or more thereof may be used in combination.

The ether solvent may be a chain ether, a hydrofluoroether, a cyclic ether, an aromatic ether, or a mixture thereof. The chain ether may include one or two oxygen atoms per molecule. A chain ether including one oxygen atom may be dialkyl ether. A chain ether including two oxygen atoms may be dialkoxy alkane represented by General Formula (1) below:

R¹O-L-OR² (1)

In Formula (1), R¹ and R² each independently denotes an alkyl group having 1 to 2 carbon atoms and L denotes an alkylene group having 1 to 3 carbon atoms. Some or all of hydrogen atoms in the alkyl group may be substituted with fluorine.

Examples of the dialkyl ether include diethyl ether and the like. Examples of the dialkoxy alkane include 1,2-dimethoxyethane, 1,2-diethoxyethane, ethoxymethoxyethane, and the like. Examples of the hydrofluoroether include 1,1,2,2-tetrafluoroethyl-2,2,2-trifluoroethylether, 1,1,2,2-tetrafluoroethyl-2,2,3,3-tetrafluoropropylether, bis(2,2,2-trifluoroethyl)ether, 1,2-bis(1,1,2,2-tetrafluoroethoxy)ethane, and the like. Examples of the cyclic ether include tetrahydrofuran, 2-methyltetrahydrofuran, tetrahydropyran, 1,3-dioxolane, 4-methyl 1,3-dioxolane, and the like. An example of the aromatic ether includes anisole.

The ether solvent may be, for example, a mixture of an ether having a boiling point of 80° C. or more and an ether having a boiling point of less than 80° C. The ether having a boiling point of less than 80° C. may have a boiling point in a range of 50 to 75° C. The ether solvent may also be a mixture of a chain ether and a hydrofluoroether, a mixture of a chain ether including two oxygen atoms per molecule and a hydrofluoroether, or a mixture of 1,2-dimethoxyethane and a hydrofluoroether. The dialkoxy alkane and the hydrofluoroether may be mixed at a molar ratio falling within a range of 50:50 to 80:20. Furthermore, a molar ratio of a content of the chain ether including two oxygen atoms per molecule and a content of LiFSI may be in a range of 1:2.0 to 2.7.

The carbonate solvent may be a cyclic carbonate, a chain carbonate, or a mixture thereof. Examples of the cyclic carbonate include ethylene carbonate, propylene carbonate, vinylene carbonate, fluoroethylene carbonate, and the like. Examples of the chain carbonate include dimethyl carbonate, diethyl carbonate, ethylmethyl carbonate, and the like. The ester solvent may be a cyclic ester, a chain carboxylate ester, or a mixture thereof. Examples of the cyclic ester include γ-butyrolactone, and the like. Examples of the chain carboxylate ester include acetate ester, butyrate ester, propionate ester, and the like. Examples of the sulfone include sulfolane, methylsulfolane, and the like. Examples of the nitrile include acetonitrile, propionitrile, and the like.

The electrolytic solution according to the present embodiment may include only the organic solvent, LiFSI, and the alkaline earth metal salt as described above. The electrolytic solution according to the present embodiment may further include an additive. The above-described organic solvent may be a compound in which hydrogen is partially replaced with fluorine, chlorine, bromine, or the like.

An oxalato complex compound, a carbonate compound, a sulfone compound, and a sulfoxide compound may be used as the additive. The oxalato complex compound and the carbonate compound have a function of facilitating formation of a carbonate of the alkaline earth metal. The sulfone compound and the sulfoxide compound have a function of facilitating formation of a sulfate of the alkaline earth metal. Formation of the carbonate or sulfate of the alkaline earth metal inhibits an ion of the alkaline earth metal from depositing on a negative electrode when charged and facilitates a homogeneous deposition reaction of lithium on the negative electrode when charged. A content of the additive is, for example, in a range of 0.1% by mass or more and 1.0% by mass or less. The content of the additive is calculated as a content of the additive relative to a total amount of the electrolytic solution (Content of additive/Total amount of electrolytic solution×100). Furthermore, the content of the additive may also be in a range of 50% by mass or more and 200% by mass or less as calculated as a content relative to that of the alkaline earth metal salt (Content of additive in electrolytic solution/Content of alkaline earth metal salt in electrolytic solution×100).

An example of the oxalato complex compound includes difluoro(oxalato)borate. The carbonate compound may be a cyclic carbonate or a chain carbonate. Examples of the cyclic carbonate include ethylene carbonate, propylene carbonate, vinylene carbonate, fluoroethylene carbonate, and the like. Examples of the chain carbonate include dimethyl carbonate, diethyl carbonate, ethylmethyl carbonate, and the like. An example of the sulfone compound includes ethylmethyl sulfone. An example of the sulfoxide compound includes dimethyl sulfoxide.

The electrolytic solution according to the present embodiment having the above-described composition includes the above-described alkali earth metal in the above-described range, enabling a lithium-metal secondary battery with a high capacity maintenance rate even after repeated charges and discharges.

In the electrolytic solution according to the present embodiment, when the organic solvent is an ether solvent, reduction resistance is improved, enabling a lithium-metal secondary battery with a higher capacity maintenance rate even after repeated charges and discharges. When the ether solvent includes 1,2-dimethoxyethane and a hydrofluoroether, a lithium-metal secondary battery can more reliably have a high capacity maintenance rate even after repeated charges and discharges.

In the electrolytic solution according to the present embodiment, when the lithium bis(fluorosulfonyl)imide has a concentration in the above-described range, a coulombic efficiency is improved, enabling a lithium-metal secondary battery with an even higher capacity maintenance rate. Moreover, when a compound such as the oxalato complex compound, the carbonate compound, the sulfone compound, and the sulfoxide compound is included in the above-described range, a lithium-metal secondary battery can have a yet even higher capacity maintenance rate.

### [Lithium-Metal Secondary Battery]

The lithium-metal secondary battery according to the present embodiment includes a separator disposed between a positive electrode and a negative electrode and impregnated with an electrolytic solution. Here, the positive electrode includes a positive electrode current collector and a positive electrode composite layer including a lithium composite oxide. Whereas, the negative electrode includes a negative electrode current collector and a lithium-metal layer.

In other words, in the lithium-metal secondary battery according to the present embodiment, a lithium metal is deposited on the negative electrode when charged and a lithium ion is eluted from the negative electrode when discharged. Therefore, in the lithium-metal secondary battery according to the present embodiment, the negative electrode may not include initially a lithium-metal layer. In this case, lithium metal is deposited on the negative electrode current collector to form a lithium metal layer by charging the lithium-metal secondary battery before the lithium-metal secondary battery is used.

The positive electrode current collector is not particularly limited. Examples thereof include aluminum foil and the like.

The positive electrode composite layer includes a lithium composite oxide and may further include other components.

The lithium composite oxide is not particularly limited. Examples thereof include LiCoO₂, Li(Ni_{5/10}Co_{2/10}Mn_{3/10}) O₂, Li (Ni_{6/10}Co_{2/10}Mn_{2/10}) O₂, Li (Ni_{8/10}Co_{1/10}Mn_{1/10}) O₂, Li (Ni_{0.8}Co_{0.15}Al_{0.05}) O₂, Li (Ni_{1/6}Co_{4/6}Mn_{1/6}) O₂, Li (Ni_{1/3}Co_{1/3}Mn_{1/3}) O₂, LiCoO₄, LiMn₂O₄, LiNiO₂, LiFePO₄, and the like. Two or more thereof may be used in combination.

Examples of the other components include a positive electrode active material other than the lithium composite oxide, a conductive aid, and a binder.

The negative electrode current collector is not particularly limited. Examples thereof include copper foil and the like.

A material of the separator is not particularly limited. Examples thereof include polyolefin such as polyethylene and polypropylene, aramide, polyimide, a fluororesin, a glass fiber, and a cellulose fiber.

Note that, the lithium-metal secondary battery according to the present embodiment may be produced using a known method.

The lithium-metal secondary battery according to the present embodiment having the above-described composition has a high capacity maintenance rate even after repeated charges and discharges since it includes the above-described electrolytic solution. Therefore, the lithium-metal secondary battery according to the present embodiment has improved capacity and cycle life.

### EXAMPLES

Although Examples of the present invention will be described hereinafter, the present invention is not limited to the Examples.

### Example 1

As an organic solvent, an ether solvent was prepared by mixing DME (1,2-dimethoxyethane) and HFE (1,1,2,2-tetrafluoroethyl-2,2,2-trifluoroethylether) at a molar ratio of 65:35. LiFSI [lithium bis(fluorosulfonyl)imide] and Ca(FSI)₂ [calcium bis(fluorosulfonyl)imide] were added to the ether solvent and stirred to dissolve LiFSI and Ca(FSI)₂. Thus, an electrolytic solution was obtained. The resulting electrolytic solution included LiFSI at a concentration of 2.35 mol/L and a content of Ca(FSI)₂ relative to LiFSI was 0.5% by mass. A composition of the resulting electrolytic solution is shown in Table 1 below.

### Examples 2 to 3 and Comparative Examples 2 to 4

The electrolytic solutions were obtained in the same manner as in Example 1, except that amounts of Ca(FSI)₂ added to the ether solvent were changed so that contents of Ca(FSI)₂ relative to LiFSI were as described in Table 1.

### Comparative Example 5

The electrolytic solution was obtained in the same manner as in Example 3, except that Ca(FSI)₂ was changed to Li(FSI)₂.

### Examples 4 to 6

The electrolytic solutions were obtained in the same manner as in Example 1, except that Ca(TFSI)₂ [calcium bis(trifluoromethane)sulfonimide] (Example 4), Mg(FSI)₂ [magnesium bis(fluorosulfonyl)imide] (Example 5), and Mg(TFSI)₂ [magnesium bis(trifluorosulfonyl)imide] (Example 6), respectively, in the same amounts as that of Ca(FSI)₂ were used instead of Ca(FSI)₂.

### Examples 7 to 101

The electrolytic solutions were obtained in the same manner as in Example 1, except that along with LiFSI and Ca(FSI)₂, FOB [difluoro(oxalato)borate] (Example 7), FEC (fluoroethylene carbonate) (Example 8), VC (vinylene carbonate) (Example 9), and DMC (dimethyl carbonate) (Example 10), respectively, were added to the ether solvent in amounts so as to give a content relative to LiFSI of 0.5% by mass.

### Comparative Example 1

The electrolytic solutions were obtained in the same manner as in Example 1, except that Ca(FSI)₂ was not added.

TABLE 1

| | Organic solvent | | | | | | |
|---|---|---|---|---|---|---|---|
| | DME | HFE | LiFSI | Alkaline earth metal salt | | Additive compound | |
| | (Molar | (Molar | Concentration | | Content | | Content |
| | ratio) | ratio) | (mol/L) | Type | (% by mass) | Type | (% by mass) |
| Example 1 | 65 | 35 | 2.35 | Ca(FSI)₂ | 0.50 | — | — |
| Example 2 | 65 | 35 | 2.35 | Ca(FSI)₂ | 0.20 | — | — |
| Example 3 | 65 | 35 | 2.35 | Ca(FSI)₂ | 0.80 | — | — |
| Example 4 | 65 | 35 | 2.35 | Ca(TFSI)₂ | 0.50 | — | — |
| Example 5 | 65 | 35 | 2.35 | Mg(TFSI)₂ | 0.50 | — | — |
| Example 6 | 65 | 35 | 2.35 | Mg(FSI)₂ | 0.50 | — | — |
| Example 7 | 65 | 35 | 2.35 | Ca(FSI)₂ | 0.50 | FOB | 0.50 |
| Example 8 | 65 | 35 | 2.35 | Ca(FSI)₂ | 0.50 | FEC | 0.50 |
| Example 9 | 65 | 35 | 2.35 | Ca(FSI)₂ | 0.50 | VC | 0.50 |
| Example 10 | 65 | 35 | 2.35 | Ca(FSI)₂ | 0.50 | DMC | 0.50 |
| Comparative | 65 | 35 | 2.35 | — | — | — | — |
| Example 1 | | | | | | | |
| Comparative | 65 | 35 | 2.35 | Ca(FSI)₂ | 0.05 | — | — |
| Example 2 | | | | | | | |
| Comparative | 65 | 35 | 2.35 | Ca(FSI)₂ | 1.00 | — | — |
| Example 3 | | | | | | | |
| Comparative | 65 | 35 | 2.35 | Ca(FSI)₂ | 2.00 | — | — |
| Example 4 | | | | | | | |
| Comparative | 65 | 35 | 2.35 | LiFSI | 1.00 | — | 0.00 |
| Example 5 | | | | | | | |

### [Production of Lithium-Metal Secondary Battery]

A Lithium-nickel-cobalt-manganese composite oxide (Li (Ni_{8/10}Co_{1/10}Mn_{1/10}) O₂) serving as a lithium composite oxide, acetylene black serving as a conductive aid, and polyvinylidene fluoride serving as a binder were mixed to obtain a coating liquid for a positive electrode composite layer.

A piece of aluminum foil having an area of 12 cm² and a thickness of 15 μm serving as a positive electrode composite layer was coated with the coating liquid for a positive electrode composite layer and dried to form 20 mg/cm² of a positive electrode composite layer. Then, this was rolled to obtain a positive electrode.

A piece of copper foil having an area of 12 cm² and a thickness of 8 μm and a piece of a porous polyolefin film having a thickness of 20 μm were used as a negative electrode current collector and a separator, respectively.

The positive electrode (positive electrode composite layer, positive electrode current collector), the separator, and the negative electrode current collector were laminated in this order, the separator was impregnated with the electrolytic solution, and then the resultant was sealed with a laminated film to obtain a lithium-metal secondary battery.

### [Charge and Discharge Test of Lithium-Metal Secondary Battery]

A discharge capacity per unit area of lithium metal is defined as 3 mAh/cm² and a charge and discharge test was performed under the below-described conditions. A lithium-metal secondary battery was attached to a jig, confined with a confining pressure of 0.05 MPa, and then left to stand at a measurement temperature (25° C.) for 1 hour. Next, a constant current charge was performed at 0.2 C. Here, the constant current charge was determined to end when a defined capacity (3 mAh/cm²) was reached, 5 hours elapsed after the start of the constant-current charge, or a voltage reached 3.3 V. At this time, a piece of lithium foil having a thickness of 20 μm adhered on a single side of a piece of copper foil having a thickness of 8 μm was used as a negative electrode. Next, a charge at 0.1 C was performed, a CCCV charge at 4.3 V was performed until reaching 0.05 C, and then a constant current discharge at 0.33 C was performed until reaching 2.65 V. Then, a charge was performed at 0.33 C, a CCCV charge was performed at 4.3 V for 10 min, and then paused for 5 min. A constant current discharge was performed until reaching 2.65 V and then paused for 5 min. Then, a CCCV charge was performed at 0.33 C until reaching 3.86 V in order to adjust a SOC to about 50%. A constant current discharge at 4.5 C was performed from 3.86 V for 10 seconds, a voltage value after 10 seconds was measured, and a direct current resistance (DCR) value was calculated from a slope between the current value and the voltage value after 10 seconds. Then, a constant current discharge at 0.33 C and a CV charge at 4.3 V were performed and then paused for 5 min. Then, a constant current discharge at 0.33 C was performed until reaching 2.65 V. Then, it paused for 5 min. This procedure was repeated 100 times.

Note that, for a discharge capacity of the lithium-metal battery, a current value at which discharge could be completed in one hour was determined as 1 C.

A capacity maintenance rate was calculated from the following expression:

Capacity maintenance rate (%)=(Capacity at 50th cycle)/(Capacity at 1st cycle)×100.

Next, a specific resistance value was calculated from the following expression:

Specific resistance(Ω·cm²)=Resistance of cell/Electrode area of positive electrode.

Table 2 shows evaluation results for the specific resistance and the capacity maintenance rate. For the capacity maintenance rate, values at the initial (1st), 10th, 50th, and 100th cycles are shown.

TABLE 2

| | Specific | Capacity maintenance rate (%) | | | |
|---|---|---|---|---|---|
| | resistance | | 10th | 50th | 100th |
| | (Ω · cm²) | Initial | cycle | cycle | cycle |
| Example 1 | 21.1 | 99.95 | 99.50 | 97.53 | 95.12 |
| Example 2 | 20.8 | 99.94 | 99.35 | 96.80 | 93.70 |
| Example 3 | 20.8 | 99.94 | 99.35 | 96.80 | 93.70 |
| Example 4 | 21.1 | 99.95 | 99.47 | 97.38 | 94.84 |
| Example 5 | 21.0 | 99.94 | 99.44 | 97.24 | 94.55 |
| Example 6 | 21.1 | 99.95 | 99.47 | 97.38 | 94.84 |
| Example 7 | 24.3 | 99.97 | 99.72 | 98.61 | 97.24 |
| Example 8 | 24.1 | 99.97 | 99.65 | 98.26 | 96.56 |
| Example 9 | 24.1 | 99.97 | 99.65 | 98.26 | 96.56 |
| Example 10 | 24.2 | 99.97 | 99.67 | 98.36 | 96.75 |
| Comparative | 22.2 | 99.88 | 98.81 | 94.17 | 88.69 |
| Example 1 | | | | | |
| Comparative | 22.6 | 99.90 | 99.00 | 95.12 | 90.48 |
| Example 2 | | | | | |
| Comparative | 22.2 | 99.88 | 98.81 | 94.17 | 88.69 |
| Example 3 | | | | | |
| Comparative | 21.1 | 99.83 | 98.31 | 91.84 | 84.35 |
| Example 4 | | | | | |
| Comparative | 22.6 | 99.85 | 98.51 | 92.77 | 86.06 |
| Example 5 | | | | | |

Table 2 demonstrates that use of the electrolytic solutions of Examples 1 to 10 containing the predetermined alkaline earth metal salts in the predetermined range according to the present invention results in lithium metal secondary batteries with an initial specific resistance of 20 to 25 Ω·cm², a high capacity maintenance rate, and a longer cycle life. In particular, use of the electrolytic solutions of Examples 7 to 10 containing the predetermined additive compounds along with the predetermined alkaline earth metal salts results in lithium metal secondary batteries with a higher capacity maintenance rate. In contrast, the electrolytic solution of Comparative Example 1 contains no alkaline earth metal salt and the electrolytic solutions of Comparative Examples 2 to 4 contain alkaline earth metal salts beyond the scope of the present invention. Therefore, the lithium metal secondary batteries using them have a low capacity maintenance rate.

What is claimed is:

1. An electrolytic solution comprising:
an organic solvent;
lithium bis(fluorosulfonyl)imide; and
an alkaline earth metal salt,
the alkaline earth metal salt being one or both of an alkaline earth metal salt of bis(fluorosulfonyl)imide or an alkaline earth metal salt of bis(trifluoromethane)sulfonimide, and
the alkaline earth metal salt being contained in a range of 0.1% by mass or more and 1.0% by mass or less.

2. The electrolytic solution according to claim 1, wherein the organic solvent is an ether solvent.

3. The electrolytic solution according to claim 2, wherein the ether solvent comprises a chain ether having two oxygen atoms per solvent molecule and a hydrofluoroether.

4. The electrolytic solution according to claim 3, wherein a molar ratio of a content of the chain ether and a content of the lithium bis(fluorosulfonyl)imide is in a range of 1:2.0 to 2.7.

5. The electrolytic solution according to claim 1, wherein the lithium bis(fluorosulfonyl)imide has a concentration in a range of 2.0 mol/L or more to 3.0 mol/L or less.

6. The electrolytic solution according to claim 1, further comprising at least one compound selected from the group consisting of an oxalato complex compound, a carbonate compound, a sulfone compound, and a sulfoxide compound,
the compound being contained in a range of 0.1% by mass or more and 1.0% by mass or less.

7. A lithium-metal secondary battery comprising
an electrolytic solution according to claim 1.
